(19) United States
(12) Patent Application Publication
(10) Pub. No.: US 2006/0061528 A1
(43) Pub. Date: Mar. 23, 2006

(54) Liquid crystal display device with reduced power consumption in standby mode

(75) Inventor: Sander Jurgen Roosendaal, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/539,854

(22) PCT Filed: Nov. 20, 2003
(86) PCT No.: PCT/IB03/05449

§ 371 Date: Jun. 20, 2005

(51) Int. Cl. G09G 3/36

(52) U.S. Cl. 345/87

(57) ABSTRACT

A reflective or transflective Liquid Crystal Display (LCD) device (100) is provided with driving means (110) operable in at least two modes, namely an active mode and a power saving standby mode. According to the invention, the (LCD) is of the normally black type, wherein a minimum driving voltage corresponds to the dark state and a maximum driving voltage corresponds to the bright state. Because of this, in the standby mode the maximum driving voltage may be altered, thereby affecting the bright state. Thus, the contrast ratio of the (LCD) remains relatively high in the standby mode. Preferably, the (LCD) comprises a layer (130) of a vertically aligned liquid crystal material.

The invention relates to a liquid crystal display device.

Liquid Crystal Displays (LCDs) are increasingly used in handheld devices such as PDAs, mobile phones, etc. For such mobile applications, LCDs have in fact become the standard display device due to low power consumption, reliability and low price.

The operation of LCDs is based on light modulation in a Liquid Crystal (LC) cell including an active layer of a liquid crystal material. By applying an electric field, the light modulation of the Liquid Crystal layer is altered and characteristics of the light passing through the LC layer are modified.

A Liquid Crystal Display generally comprises a plurality of picture elements (pixels) arranged in rows and columns. Each pixel of the display is addressable individually, for this purpose the driving means for driving the LC cell usually comprise a separate pixel driver for each picture element of the display.

LCDs are generally operable in one or both of two modes, namely a transmissive mode and a reflective mode. In a transmissive LCD, light originating from a backlight is modulated by the LC layer. Transmissive LCDs generally have a good contrast ratio, however when used in an outside environment the display becomes practically unreadable. More importantly, the backlight has a relatively high power consumption, thereby for instance reducing the battery life of a mobile device.

Therefore, mobile devices generally comprises an LCD that is at least partially arranged in a reflective mode. The LC layer in a reflective mode modulates ambient light that impinges on the display, and comprises a reflector which reflects modulated ambient light back towards the viewer, whereby the light generally passes through the LC layer again. In general, reflective LCDs are well readable outside, however indoors their reflective brightness is too low to be practically usable.

In a mobile device, which is generally provided with a chargeable power source such as a battery, it is desirable to have a power consumption of the LCD that is as low as possible, so that the time during which the mobile device is usable without recharging the power source is as long as possible.

For this purpose, the driving means for driving the reflective LCD such may be operable in either of at least two modes, namely an active mode wherein the viewing characteristics are as good as possible allowing a user to use the mobile device normally, and a standby mode wherein the power consumption of the LCD is reduced. However, in all previous solutions, the viewing characteristics of the LCD, most notably the contrast ratio, are unacceptably low when the driving means are in the standby mode. This has the result that it is difficult for a user to read information displayed on the LCD in the standby mode.

It is, amongst others, an object of the invention to provide an LCD that has a reduced power consumption, while maintaining good viewing characteristics, in particular a relatively high contrast ratio, at all times.

This object is achieved by means of an LCD according to the invention as specified in the independent Claim 1, and by means of a mobile device according to the independent Claim 11. Further advantageous embodiments of the LCD are specified in the dependent Claims 2-10.

The invention is based on the recognition that in a reflective LCD, the contrast ratio is predominantly determined by the amount of reflection that occurs when the LCD is in its dark state. If this reflection increases by a relatively limited amount, this will be perceived by a viewer as a relatively large change in contrast ratio.

In a normally black liquid crystal cell, the dark state (black color) corresponds to a minimum driving voltage, which is usually 0 Volts, and the bright state (white color, or full color) corresponds to a maximum driving voltage. For decreasing the power consumption of the LCD, the difference between the minimum and maximum driving voltages should be reduced, while at the same time the maximum driving voltage should be as low as possible.

The use of a normally black liquid crystalline (LC) cell now allows the LCD to be provided with a power saving standby mode for operating the driving means, in which standby mode the power consumption may be reduced by altering the maximum driving voltage as generated by the driving means, whereby the contrast ratio of the LCD deteriorates less because this altered maximum driving voltage now affects the bright state. Thus, in the standby mode, a user now perceives a better display contrast. This is advantageous since it is now generally easier for the user to read information that is displayed in the standby mode.

Preferably, a maximum drive voltage generated by the driving means in the standby mode is lower than a maximum drive voltage generated by the driving means in the active mode.

The reduction of the drive voltage reduces the power dissipated in the pixel driver. Although the brightness of the pixel is then reduced, this is relatively unnoticeable to a viewer, because it is the bright state of the pixel that is affected. In the standby mode, the displayed image still has a relatively high contrast ratio.

Alternatively, a frame frequency of a drive signal generated by the driving means in the standby mode is lower than a frame frequency of a drive signal generated by the driving means in the active mode. This is particularly useful if the LCD is of the so-called active matrix type, wherein each pixel comprises a Thin Film Transistor (TFT), which retains the voltage supplied by the pixel driver after the latter has been switched off.

Between subsequent driving pulses with which a pixel driver is supplied, the pixel is isolated from the rest of the display. Because of imperfection in the liquid crystal material and the TFT, charge leaks away after switching off the pixel, so that the pixel voltage drops and the perceived intensity of the pixel changes. This is especially noticeable when the frame frequency is lowered.

However, an LCD according to the invention is affected less, since again a bright state of the pixel is affected. A prior art LCD would suffer from a noticeable deterioration of the contrast ratio if the frame frequency were lowered, since a pixel set to a dark color would brighten considerably between subsequent addressing pulses. As a result, the contrast ratio would drop unacceptably rendering the device unreadable to a viewer.

According to the invention, the lowering of the frame frequency does result in a loss of brightness, but the displayed image still has a relatively high contrast ratio. As a net effect, a viewer is more able to read image information on the display, while the driving means are operated in standby mode.

A more preferred embodiment is a combination of both methods, i.e. in the standby mode, the driving means generates a lower driving voltage having a reduced frame frequency.

Since it is desirable to use a mobile device both in indoor and outdoor environments, state of the art mobile devices generally use a so-called transflective LCD which is operable in both the reflective and transmissive mode at the same time. In a transflective LCD, for example, each pixel of the LC cell comprises a transmissive and a reflective sub-pixel.

Preferably, the liquid crystalline cell of the LCD comprises a layer of a vertically aligned liquid crystalline (LC) material. Such an LCD will also be indicated as vertically aligned (VAN) LCD' in the following.

In a VAN LCD, liquid crystalline material having a negative dielectric anisotropy is oriented homeotropically at low voltages. If a voltage higher than a threshold voltage is applied, the orientation of the liquid crystalline material starts to change towards planar alignment. If a reflective VAN LCD is combined with a λ/4 compensation layer, a normally-black LCD is obtained. Such a reflective normally-black VAN LCD is known per se from U.S. Pat. No. 6,108,064.

This configuration is found to be particularly advantageous if the LCD is a transflective LCD. Preferably, the layer of vertically aligned liquid crystalline material of the LCD is then arranged between a first polarizer and a second polarizer being oriented at a right angle with the first polarizer.

In this case, at a minimum voltage, light originating from the backlight is polarized by the first polarizer, passes through the vertically aligned LC layer without modification, and is extinguished by the second polarizer having its orientation perpendicular to the first polarizer. Thus, also the transmissive sub-pixels of the LCD are of the normally-black type.

As set out earlier, a quarter wave (λ/4) compensation layer is generally arranged on the viewing side of the reflective normally black VAN LCD. When a conventional λ/4 compensation layer is applied, for the transmissive sub-pixels, the retardation of this layer has to be compensated for. Thus, a further λ/4 compensation layer is required on the backlight side.

However, more preferably, the compensation layer on the viewing side is an in-cell patterned compensation layer as described in the applicant's unpublished international patent application PCT/IB2002/02971 (PHNL010603). Such a layer may be arranged to have a retardation of λ/4 over the reflective sub-pixels and a retardation of 0 over the transmissive sub-pixels.

In a normally black transflective LCD, it is desirable that the maximum driving voltage for the reflective sub-pixel and the maximum driving voltage for the transmissive sub-pixel are approximately equal. Thus, the voltages required to obtain the highest reflection for the reflective sub-pixels and the highest transmission for the transmissive sub-pixel should be about the same.

In this case, the driving means of the LCD are relatively simple, and power consumption of the LCD is further reduced.

The driving voltage-reflection of the reflective sub-pixels, and the driving voltage-transmission characteristics of the transmissive sub-pixels, may be tuned by altering the cell gap of the reflective and transmissive sub-pixels respectively. The cell gap is understood to be the thickness of the liquid crystal layer in the sub-pixel.

Preferably, a cell gap for the transmissive sub-pixel is then between 1.6 and 2 times a cell gap for the reflective sub-pixel. More preferably, the cell gap for the transmissive sub-pixel is between 1.7 and 1.9 times the cell gap for the reflective sub-pixel, and most preferably the cell gap for the transmissive sub-pixel is about 1.8 times the cell gap for the transmissive sub-pixel.

These and other aspects of the invention will now be elucidated with respect to the accompanying drawings. Herein:

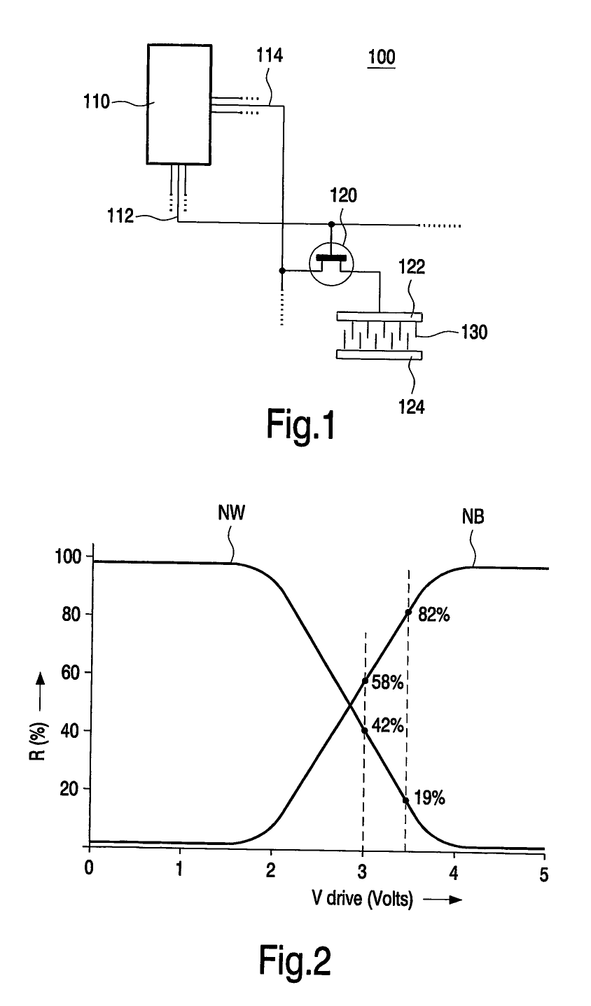

FIG. 1 shows a schematic view of a pixel driver in an LCD;

FIG. 2 shows driving voltage-reflection curves for a normally white and a normally black LCD;

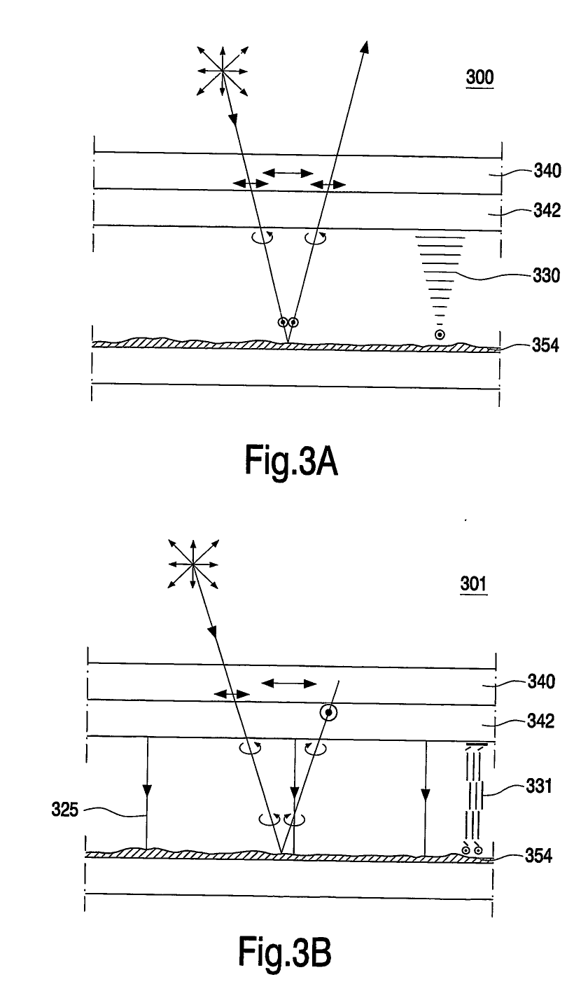

FIGS. 3A and 3B show a conventional reflective normally white liquid crystalline cell, in its bright state and dark state respectively;

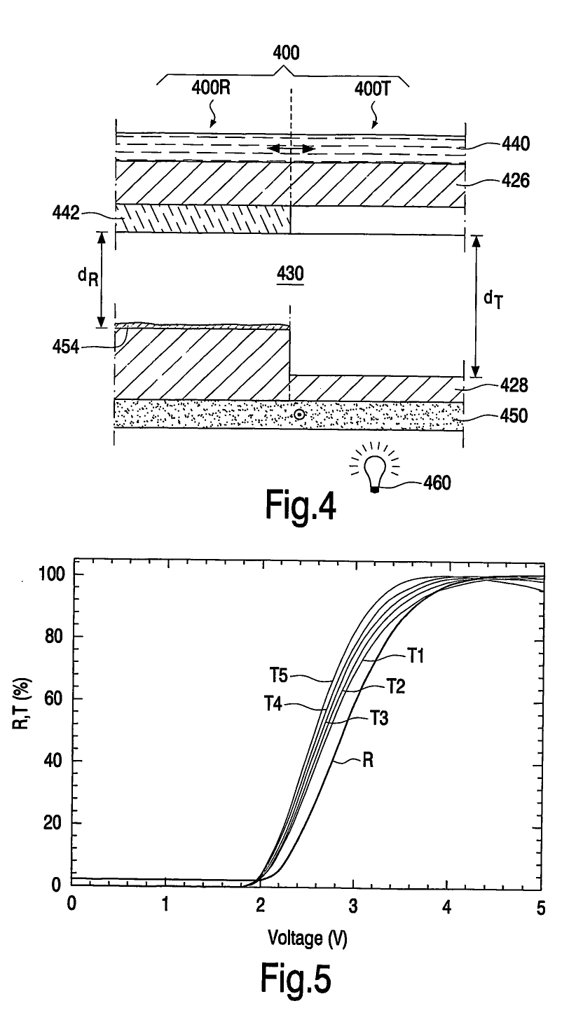

FIG. 4 shows a preferred embodiment of a transflective normally black liquid crystalline cell, and

FIG. 5 shows driving voltage-reflection and driving voltage-transmission curves for a normally black transflective LCD according to the invention.

A Liquid Crystal Device includes a Liquid Crystal (LC) cell being provided with an active layer 130 of a liquid crystal material, one pixel of which cell is displayed in FIG. 1. The Liquid Crystal (LC) layer 130 is sandwiched between two glass plates comprising an upper electrode 122 and a lower electrode 124. The LC layer 130 is able to modulate the properties of light passing through it. By applying a voltage difference over the electrodes 122, 124, an electric field is generated over the LC layer 130, and the light modulation by the layer changes.

The electric field is applicable pixelwise, i.e. the Liquid Crystal Display comprises a plurality of pixels arranged in rows and columns, and the driving voltage may be generated separately for each pixel. For this purpose, the driving means 110 comprise row drivers 112 and column drivers 114.

If the LCD is of the active matrix type, each pixel comprises a Thin Film Transistor (TFT) 120. The gate of the TFT is for example connected to a corresponding row driver 112, and the source of the TFT is for example connected to a corresponding column driver 114. The drain of the TFT is then preferably connected to the upper electrode 122 of the LC cell.

According to the invention, the driving means 110 are operable in at least two modes, namely an active mode allowing for normal use of the LCD, and a standby mode for reducing the power consumption of the LCD.

In the standby mode, the maximum driving voltage may be reduced as compared to the active mode. For example, in the active mode the maximum driving voltage is 4.5 Volts, whereas in the standby mode it is 3 Volts, or 3.5 Volts. As explained earlier, because the LC layer 130 is part of a normally black LC cell according to the invention, the reduction in maximum driving voltage affects the bright state of the LCD, so that the contrast ratio in the standby mode is still comparatively high.

This is illustrated in the graph of FIG. 2, which shows a driving voltage-reflection (Vdrive-R) curve for both a normally white (NW) LCD and a normally black (NB) LCD. These curves are given by way of example, and in practice depend on the characteristics of the actual display being used. It is assumed that in the bright state the highest reflection occurs, which is set to 100%. In the dark state the reflected light amounts to 2% of the reflection in the bright state. The contrast ratio is defined as the quotient of the reflection in the bright state and the reflection in the dark state, and is thus largely determined by the latter, as the inventor has realized.

In this example, the maximum contrast ratio, i.e. the contrast ratio in the active mode, is 50. The maximum driving voltage in the active mode is 4.5 Volts.

In the standby mode, the maximum driving voltage is for example lowered to 3.5 Volts. In this case, the reflection of the dark state in the normally white LCD is about 19%, so that the contrast ratio is reduced to (100/19)=5.3. The reflection of the bright state in the normally black LCD is about 82%, so that the contrast ratio in this case is only reduced to (82/2)=41.

Similarly, when the maximum driving voltage is lowered to 3 Volts, the normally white LCD has a contrast ratio of (100/42)=2.4, whereas the normally black LCD still has a contrast ratio of (58/2)=29.

In a reflective LCD, a contrast ratio of at least 10 is required so that a viewer can read information displayed on the LCD with relative ease. Thus, it is clear that in a normally white LCD it is not or hardly possible to use a standby mode which uses a lower maximum driving voltage, as this renders the display unreadable. However, according to the invention, such a standby mode may be implemented in a normally black LCD, while in the standby mode still a sufficiently high contrast ratio is achieved, allowing for good viewing of the LCD.

Alternatively, in the standby mode, a frame frequency of the driving signal may be lower in the standby mode as compared to the active mode. Ideally, a pixel is isolated from the driving means 110 by TFT 120, and maintains the charge supplied during a driving pulse. However, because the TFT 120 is not an ideal transistor, and the LC layer 130 has a certain conductance value, charge in practice leaks away between subsequent driving pulses. This has the effect that the pixel voltage drops and the color of the pixel is affected.

In the normally black LCD according to the invention, this problem is alleviated. When charge leaks away, in this case the reduction in voltage again causes the bright state to be affected so that the contrast ratio may still be comparatively high. Thus, although charge leakage still occurs, this has a comparatively small effect on the contrast ratio.

This insight may be advantageously used. The normally black LCD allows the time between driving pulses to be increased, and thus the frame frequency of the driving signal may be lower. Even the resulting increased charge leakage still has a relatively limited effect on the contrast ratio of the LCD.

Both features may also be combined, i.e. a reduced frequency driving using lower amplitude driving pulses applied to the LCD. For instance, a driving pulse having maximum driving voltage of 3.5 Volts is used. The charge leakage effect subsequently reduces the pixel voltage such, that the pixel voltage is about 3 Volts just before the arrival of a subsequent driving pulse.

In FIG. 1, only a single pixel of the LC layer 130 with its corresponding TFT 120 and drivers 112, 114 is indicated. It is to be understood that an actual Liquid Crystal Display has a large number of pixels, for example 720×576. Furthermore, in a color LCD, each pixel generally comprises three color sub-pixels, each provided with a separate pixel driver and TFT.

As set out in the above, an applied electric field over the LC layer causes the light modulating properties of the layer to change.

For example, in an LCD based on the Twisted Nematic (TN) effect, the liquid crystal molecules align with the applied electric field, which is oriented perpendicularly to the LC layer. The operation of a conventional reflective normally white TN liquid crystalline cell is now elucidated with reference to FIG. 3. Only functional layers are displayed in the Figure, for clarity reasons glass plates, color filters, electrodes and TFTs are not shown.

In a conventional reflective TN liquid crystalline cell 300 at zero voltage or minimum driving voltage, unpolarized ambient light passes through a linear polarizer 340 and a λ/4 compensation layer 342 before entering the LC layer 330. Thereby, the incident ambient light is circularly polarized before entering the LC layer 330. On the other side of the LC layer 330, a reflector 354 is arranged which reflects the incident ambient light that passed the LC layer 330 back towards a viewer.

An initial twist angle of the liquid crystal molecules is for example 90 degrees. Without any voltage, a birefringence of the LC layer causes the light to be linearly polarized after having passed through the LC layer 330. The light is then reflected back, and has its original circular polarization when arriving at the λ/4 compensation layer 342. Thereby, light is able to pass back through the polarizer 340 and thus, ambient light is able to pass through the LC cell 300. At zero voltage or minimum driving voltage, the normally white LC cell 300 is thus in its bright state.

However, when a maximum driving voltage is applied between the electrodes, the liquid crystalline cell is changed to its dark state 301 as indicated in FIG. 3B.

The liquid crystal molecules align with the applied electric field indicated by field lines 325, and the initial twist angle of the molecules disappears. Thus, light passing through the modified LC layer 331 effectively experiences a low birefringence, and consequently the light is still circularly polarized when it arrives at the reflector 352. Upon reflection, the circular polarization is reversed causing the light to have an opposed circular polarization when arriving at the λ/4 compensation layer 342. In this case, light is absorbed by the polarizer 340.

The reflective TN LCD in the above described example is a normally white LCD, since when no voltage is applied, the highest amount of light is able to pass through the LC cell and the display is in its bright state.

The invention on the other hand relies on the use of a normally black liquid crystalline cell which preferably has a so-called vertically aligned (VAN) liquid crystal layer. The liquid crystal material applied therein has a negative dielectric anisotropy (Δε<0), so that in presence of an electric field the material has a tendency to align at a right angle with the electric field lines. By suitable treatment of the glass plates between which the LC layer is sandwiched, the liquid crystal material may initially be oriented perpendicular to said plates. Thereby, a VAN liquid crystal layer is obtained.

FIG. 4 shows a transflective, normally black liquid crystal cell 400 having a layer of a vertically aligned liquid crystal material. A single pixel of the cell, comprising a reflective sub-pixel 400R and a transmissive sub-pixel 400T, is shown. In practical designs, the transmissive sub-pixel is usually enclosed by the reflective sub-pixel, however this is not indicated here.

The layer 430 of vertically aligned liquid crystal material has a different thickness for the reflective and transmissive sub-pixels. Thus, the cell gap d_{R} for the reflective sub-pixel is different than the cell gap d_{T} for the transmissive sub-pixel.

The liquid crystal material is sandwiched between a front glass plate 426 and back glass plate 428, which glass plates comprise electrodes (not drawn) for applying an electric field over the liquid crystal layer 430. For this purpose, in an LCD the electrodes are connected to driving means 110 which, according to the invention, are operable in at least an active mode and a power-saving standby mode.

Without any voltage being applied, the liquid crystal molecules are essentially vertically aligned, i.e. oriented perpendicularly to the layers of the display. The effective birefringence of the liquid crystal layer 430 for light passing through it is now substantially zero.

A polarizer 440, 450 is provided on the outside of each glass plate, the orientation of said polarizers being mutually perpendicular. Thus, the liquid crystal layer 430 is arranged between crossed polarizers.

An in-cell patterned compensation layer 442 is arranged on the liquid crystal side of the front glass plate 426. The retardation of this compensation layer is essentially zero for the transmissive sub-pixel 400T, and approximately λ/4 for the reflective sub-pixel 400R. Such in-cell patterned compensation layers, and methods of manufacturing the same, are described in the applicant's unpublished international patent application PCT/IB2002/02971 (PHNL010603). In this example, the compensation layer comprises substantially isotropic material for the transmissive sub-pixel 400T leading to a retardation value of zero.

For the reflective sub-pixel 400R, the back glass plate 428 is coated with an internal diffusive reflector 454 on the side of the liquid crystal material.

At the outside of the back glass plate 428, a backlight 460 is arranged which provides the light for the transmissive sub-pixel 400T.

The liquid crystal cell is of the normally-black type, so that substantially no light exits from the cell. For the reflective sub-pixel 400R, the light absorption mechanism relies on the reversion of circular polarization at the reflector 454, as explained earlier in the description of FIG. 3. For the transmissive sub-pixel 400T, the absorption of light originating from the backlight 460 is caused by the crossed polarizers 440, 450. The light is linearly polarized by the back polarizer 450, and passes through the LC layer 430 without modification. Thus, the linearly polarized light arrives at the front polarizer 440 having perpendicular orientation to the back polarizer 450, and is effectively absorbed.

On the other hand, if a maximum driving voltage is applied between the electrodes on the front plate 426 and back plate 428, the liquid crystal cell is in its bright state. The liquid crystal molecules now align substantially in the plane of the display surfaces, i.e. substantially parallel to the plates 426, 428. Within this plane, the molecules align along a director which is generally oriented at a 45 degree angle with both polarizers 440, 450. Thereby, light passing through the LC layer 430 experiences an effective birefringence and is modulated such, that it is able to pass the front polarizer 440 and exit from the LC cell.

Thus, the dark state is achieved at zero voltage, and the bright state is achieved at a maximum driving voltage. The LC cell described above is a preferred embodiment of the normally-black type LC cell applied in an LCD according to the invention. In particular, the reflective sub-pixel has a low reflection in the dark state, which enables the contrast ratio to be particularly high, particularly in an outdoors environment, both in the standby mode and in the active mode.

Driving voltage-reflection/transmission curves have been obtained from an LC cell as described in the above, whereby several characteristics of the LC cell were chosen as follows:

| | | |
|---|---|---|
| Anisotropy (Δε) of LC material | −6.7 | |
| Birefringence (Δn) of LC material | 0.1 | |
| Cell gap (d_{R}) for reflective sub-pixels | 2 | μm |
| Cell gap (d_{T}) for transmissive sub-pixels | | varied |
| Orientation of top polarizer | 0 | degrees |
| Orientation of bottom polarizer | 90 | degrees |
| Orientation of LC director | 45 | degrees |
| Orientation of λ/4 compensation layer | −45 | degrees |
| Retardation of λ/4 compensation layer | 138 | nm |

Using an LC cell as described in the above, the curves shown in FIG. 5 were obtained.

The curve indicated by R is the driving voltage-reflection curve for the reflective sub-pixel, which has a (fixed) cell gap d_{R} of 2 micrometers. The other curves T1-T5 are driving voltage-transmission curves for the transmissive sub-pixel, whereby varying cell gaps d_{T} for the transmissive sub-pixel were used:

| curve | cell gap |
|---|---|
| T1 | 3.5 μm |
| T2 | 3.6 μm |
| T3 | 3.7 μm |
| T4 | 3.8 μm |
| T5 | 4.0 μm |

It can be observed in the Figure that, with respect to the curve steepness and the voltage needed to obtain the highest reflection and transmission, the curve indicated by T2 matches the reflective curve R best. Thus, preferably, the cell gap d_{T} of the transmissive sub-pixel is 3.6 micrometers, when a cell gap d_{R} of the reflective sub-pixel is 2 micrometers. This makes driving of the LCD simpler, requiring comparatively simple driving means that have a relatively limited power consumption.

The drawings are schematic and not drawn to scale. While the invention has been described in connection with preferred embodiments, it should be understood that the invention should not be construed as being limited to the preferred. Rather, it includes all variations which could be made thereon by a skilled person, within the scope of the appended claims. Other known power-saving techniques for Liquid Crystal Display devices may readily be implemented into a Liquid Crystal Display device according to the present invention.

In summary, a reflective or transflective Liquid Crystal Display (LCD) device (100) is provided with driving means (110) operable in at least two modes, namely an active mode and a power saving standby mode. According to the invention, the LCD is of the normally black type, wherein a minimum driving voltage corresponds to the dark state and a maximum driving voltage corresponds to the bright state. Because of this, in the standby mode the maximum driving voltage may be altered, thereby affecting the bright state. Thus, the contrast ratio of the LCD remains relatively high in the standby mode. Preferably, the LCD comprises a layer (130) of a vertically aligned liquid crystal material.

1. A Liquid Crystal Display (LCD) device, having a normally-black liquid crystalline cell at least partially arranged as a reflective liquid crystalline cell,
said liquid crystal display device comprising driving means for driving the liquid crystalline cell, which driving means are operable in
an active mode allowing for normal use of the device, and
a standby mode for reducing power consumption of the device.

2. The Liquid Crystal Display device of claim 1, wherein a maximum drive voltage generated by the driving means in the standby mode is lower than a maximum drive voltage generated by the driving means in the active mode.

3. The Liquid Crystal Display device of claim 1, wherein a frame frequency of a drive signal generated by the driving means in the standby mode is lower than a frame frequency of a drive signal generated by the driving means in the active mode.

4. The Liquid Crystal Display device of claim 1, wherein the liquid crystalline cell comprises a layer of a vertically aligned liquid crystalline material.

5. The Liquid Crystal Display device of claim 1, wherein the liquid crystalline cell is a transflective liquid crystalline cell.

6. The Liquid Crystal Display device of claim 5, wherein the liquid crystalline cell comprises a layer of a vertically aligned liquid crystalline material.

7. The Liquid Crystal Display device of claim 6, wherein the layer of the vertically aligned liquid crystalline material is arranged between a first polarizer and a second polarizer being oriented at a right angle with the first polarizer.

8. The Liquid Crystal Display device of claim 5, wherein a λ/4 compensation layer is arranged adjacent at least reflective parts of the liquid crystalline cell.

9. The Liquid Crystal Display device of claim 6, wherein a cell gap for a transmissive sub-pixel of the liquid crystalline cell is between 1.6 and 2 times a cell gap for a reflective sub-pixel of the liquid crystalline cell.

10. The Liquid Crystal Display device of claim 9, wherein the cell gap for the transmissive sub-pixel is about 1.8 times the cell gap for the reflective sub-pixel.
